(19) United States
(12) Patent Application Publication
(10) Pub. No.: US 2006/0162335 A1
(43) Pub. Date: Jul. 27, 2006

(54) Turbocharger/turbogenerator engine system with inter-unit exhaust after-treatment device

(75) Inventor: Carl Thomas Vuk, Denver, IA (US)

Correspondence Address: DEERE & COMPANY, ONE JOHN DEERE PLACE, MOLINE, IL, 61265, US

(73) Assignee: Deere & Company, a Delaware corporation

(21) Appl. No.: 11/043,667

(22) Filed: Jan. 26, 2005

(51) Int. Cl. F02B 33/44

(52) U.S. Cl. 60/612

(57) ABSTRACT

An engine system includes an internal combustion engine having an air intake and an exhaust outlet. An electric generator is driven by the engine. A turbocharger includes a primary turbine driven by engine exhaust gasses and a compressor driven by the turbine. The compressor provides compressed inlet air to the air intake. A turbo-generator includes a secondary turbine driving a secondary electric generator. An exhaust pipe communicates exhaust from the primary turbine to the secondary turbine. An emissions after-treatment unit is installed in the exhaust pipe between the primary and secondary turbines.

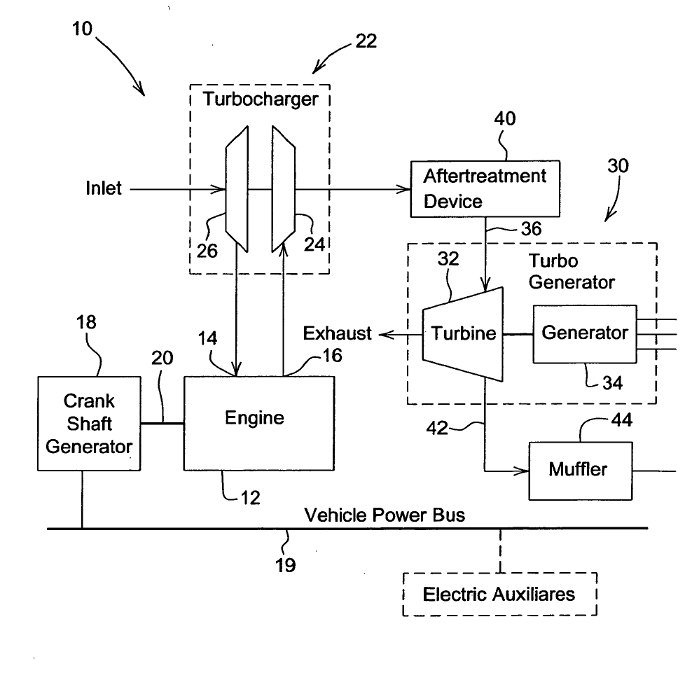

### BACKGROUND

The present invention relates to a turbocharger/turbogenerator engine system.

Exhaust gas emissions from Diesel engines are being regulated to ever more stringent levels. Emissions controlled engines emit greater amounts of the fuel's available energy through the exhaust gasses. Exhaust energy recovery devices such as turbo compounding systems that extract exhaust energy through the application of a second power turbine are increasingly viable. For example, U.S. Pat. No. 4,665,704, issued in 1987 to Hartwig, shows an internal combustion engine with a turbocharger and a secondary turbine driving an electric generator. However, the Hartwig system does not include any after-treatment devices.

Exhaust emissions can be reduced by after-treatment devices, such as Diesel particulate filters and NOx traps. These devices are costly and are difficult to fit compactly into engine compartments. Particulate filters accumulate carbonaceous material that eventually causes the filter to become plugged. Under high temp conditions the carbon “lights off” and burns, regenerating the filter and reducing the restriction. This requires an elevated exhaust temperature, typically above 275 degrees C. If this temperature is not achieved when the filter becomes plugged, the filter can be damaged.

U.S. Pat. No. 4,202,176, issued in 1980 to Mezger, shows an internal combustion engine with a turbocharger and a catalytic device located between the exhaust manifold and the turbocharger turbine, or located between the turbocharger turbine and the muffler, thus directly upstream of the muffler. There are disadvantages to both these alternatives. For example, placing an after-treatment device between the engine and the turbocharger could be detrimental because the exhaust temperatures here might be too hot for optimal NOx adsorber performance. This would also move the turbocharger further from the engine, complicating packaging. The internal added accumulator volume in the after-treatment device would also destroy any turbocharger “pulse effect”, which is often employed to provide increased low speed torque. The accumulator volume effect would also be detrimental to engine response and would increases turbo lag, thus degrading performance and emissions.

Finally, an after-treatment device directly upstream of the muffler would be exposed to lower exhaust temperatures which would make it difficult for the particulate trap to light off at part load conditions. Because of the low pressure at this point in the exhaust flow stream, the device would have to be relatively large, thus increasing the size of the engine system.

### SUMMARY

Accordingly, an object of this invention is to provide an engine turbocharger/turbogenerator system which includes an emission after-treament device.

These and other objects are achieved by the present invention, wherein an engine system includes an internal combustion engine having an air intake and an exhaust outlet. An electric generator is driven by the engine. A turbocharger includes a primary high pressure turbine driven by engine exhaust gasses and a compressor driven by the turbine. The compressor provides compressed inlet air to the air intake. A turbo-generator includes a secondary turbine driving a secondary electric generator. An exhaust pipe communicates exhaust from the primary turbine to the secondary turbine. An emissions after-treatment unit is installed in the exhaust pipe between the primary and secondary turbines.

### BRIEF DESCRIPTION OF THE DRAWINGS

The sole FIGURE is a simplified schematic diagram of an engine system according to the present invention.

### DETAILED DESCRIPTION

Referring to the FIGURE, an engine system 10 includes an internal combustion engine 12, such as a Diesel engine, which includes an air intake 14 and an exhaust outlet 16. A primary electric generator 18 is driven by a crankshaft 20 of the engine 12. Generator 18 provides electrical power to a vehicle power bus 19. A turbocharger 22 includes a primary turbine 24 driven by engine exhaust gasses and a compressor 26 driven by the turbine 24. The compressor 26 provides compressed inlet air to the air intake 14.

A turbo-generator 30 includes a secondary turbine 32 which drives a secondary electric generator 34. Exhaust line 36 communicates exhaust from the primary turbine 24 to the secondary turbine 32. An emissions after-treatment unit 40 is installed in the exhaust line 36 between the primary turbine 24 and the secondary turbine 32. The after-treatment device 40 preferably consists of both a particulate trap and NOx reduction device. An exhaust outlet line 42 communicates exhaust from turbine 32 to a muffler 44.

By placing after-treatment devices between the turbocharger turbine and a downstream turbo compounding power turbine, system performance and component packaging are enhanced.

By placing the after-treatment device 40 between turbine stages 24 and 32, gasses entering the after-treatment device 40 are substantially hotter and of higher density than if placed directly upstream of the muffler 44. Typical power turbines operate at pressure ratios ranging from 1.0-2.0, which produces exhaust temperatures as much as 100 degrees C. hotter than on a conventional engine system. Higher temperatures are helpful in lighting off particulate filters and in regenerating NOx traps. The increased gas density in the catalyst also increases reaction rates due to closer spacing of the exhaust gas molecules. As a result, the after-treatment device can be made smaller, which makes possible a compact system and reduces costs. Higher temperatures in a particulate trap enable burning of trapped particulates at lighter engine loads, thus minimizing pressure drops, improving performance, and increasing particulate filter durability.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

We claim:

1. An engine system, comprising:
an internal combustion engine having an air intake and an exhaust outlet;
an electric generator driven by the engine;
a turbocharger having a primary turbine driven by engine exhaust gasses and a compressor driven by the primary turbine, the compressor providing compressed inlet air to the air intake;
a turbo-generator comprising a secondary turbine driving a secondary electric generator;
an exhaust pipe communicating exhaust from the primary turbine to the secondary turbine; and
an emissions after-treatment unit in the exhaust pipe between the primary and secondary turbines.

2. An engine system having an internal combustion engine having an air intake and an exhaust outlet, an electric generator driven by the engine, a turbocharger having a primary turbine driven by engine exhaust gasses and a compressor driven by the turbine, the compressor providing compressed inlet air to the air intake, a turbo-generator comprising a secondary turbine driving a secondary electric generator, and an exhaust pipe communicating exhaust from the primary turbine to the secondary turbine, characterized by:
an emissions after-treatment unit in the exhaust line between the primary and secondary turbines.
